(19) United States
(12) Patent Application Publication
(10) Pub. No.: US 2026/0046456 A1
(43) Pub. Date: Feb. 12, 2026

(54) METHOD AND APPARATUS FOR VIDEO ENCODING AND DECODING

(71) Applicant: RESEARCH & BUSINESS FOUNDATION SUNGKYUNKWAN UNIVERSITY, Suwon-si (KR)

(72) Inventors: Byeungwoo JEON, Suwon-si (KR); Jonghoon YIM, Suwon-si (KR); Yongseong KIM, Suwon-si (KR); Sungjin YE, Suwon-si (KR)

(21) Appl. No.: 19/234,006

(22) Filed: Jun. 10, 2025

(30) Foreign Application Priority Data
Jun. 10, 2024 (KR) 10-2024-0075264

(51) Int. Cl. H04N 19/70; H04N 19/117

(52) U.S. Cl. CPC H04N 19/70; H04N 19/117

(57) ABSTRACT

According to one embodiment of a first aspect of the present invention, a method for encoding a video using a video encoding apparatus, the method comprising: determining whether patch video content containing a patch is included in an input video; determining a value of a patch video syntax indicating whether the patch video content is included in the input video, based on a result of a determination; and encoding the input video based on the value of the patch video syntax.

### TECHNICAL FIELD

The present invention relates to a method and apparatus for encoding and decoding video.

The present application claims priority to Korean Patent Application No. 10-2024-0075264, filed Jun. 10, 2024, the entire contents of which are hereby incorporated by reference in its entirety.

### BACKGROUND ART

A video codec such as high efficiency video coding (HEVC) or versatile video coding (VVC) may perform intra-picture prediction or inter-picture prediction in order to reduce spatial redundancy of pixel values within a picture and temporal redundancy between adjacent pictures. In this case, an encoder may perform encoding by transforming and quantizing a residual, which is a difference between a prediction result and an original image, and then performing entropy coding along with information on a prediction method. In addition, a decoder may generate a predictor using information received from the encoder, and add the residual through an inverse quantization and an inverse transformation to reconstruct an image.

A deblocking filter (DBF) is a technique for removing blocking artifacts that occur while processing a picture in block units, and, as illustrated in FIG. 1, may reduce discontinuities between pixel values around blocks boundaries.

As illustrated in FIG. 2, a plenoptic camera includes a micro lens array (MLA) between a main lens and an image sensor, unlike a conventional camera. That is, light rays passing through the main lens may reach the image sensor via each micro lens. Accordingly, a plenoptic video recorded by the plenoptic camera may be acquired, which includes spatial and temporal information in addition to viewpoint information.

MPEG immersive video (MIV) refers to a standard technology that generates an atlas based on images acquired from multiple views and depth images from each view, and then compresses the atlas using a codec such as HEVC or VVC to generate a bitstream. In this case, the atlas may refer to a data structure or a set including information on a scene, object, or dataset. An atlas sub-bitstream may include information on patches, such as a packing order, position, rotation information, and the source view number including the patches.

Both the plenoptic video and the atlas of MIV may undergo in common a predetermined preprocessing process of generating a patch video before being encoded by a video codec. For example, in the plenoptic video, a preprocessing process may involve cutting the interior of a micro image (MI) of each picture into rectangular patches, and concatenating the patches to generate a patch video. As another example, in the atlas of MIV, a preprocessing process may involve concatenating rectangular shapes, which are cut from additional views that do not overlap with a basic view, to the basic view to generate a patch video.

In conventional video compression technologies when intact video content and patch video content such as the plenoptic video and the atlas of MIV are mixed and encoded in one video as in FIG. 6, it is unfeasible to identify them.

In addition, a conventional video codec applies a DBF to a reconstructed picture in order to reduce discontinuities between pixel values around blocks boundaries, where prediction and reconstruction are performed in block units. In this case, when a video composed of patches acquired from different viewpoints, such as a plenoptic video or the atlas of MPEG immersive video, is compressed using a conventional video codec, a phenomenon may occur in which image quality is unintentionally degraded due to the DBF is applied to boundaries between patches.

### DISCLOSURE

### Technical Problem

An object to be solved by the present invention is to provide a method and apparatus for encoding and decoding video, which may indicate or identify whether patch video content is included in the video.

However, the problem to be solved by the present disclosure is not limited to that mentioned above, and other problems to be solved that are not mentioned may be clearly understood by those of ordinary skill in the art to which the present disclosure belongs from the following description.

### Technical Solution

According to one embodiment of a first aspect of the present invention, a method for encoding a video using a video encoding apparatus, the method comprising: determining whether patch video content containing a patch is included in an input video; determining a value of a patch video syntax indicating whether the patch video content is included in the input video, based on a result of a determination; and encoding the input video based on the value of the patch video syntax.

The method may further comprise encoding the input video and outputting the encoded video.

The method may further comprise generating and outputting a bitstream based on the encoded video and a value of the patch video syntax.

The method may further comprise determining a value of a DBF (deblocking filter) syntax indicating whether to apply a DBF based on the value of the patch video syntax.

The patch may include a plurality of patches. In this case, when the value of the DBF syntax is 0, the DBF may be applied to block boundaries within the input video. Also, when the value of the DBF syntax is 1, the DBF may not be applied to block boundaries that correspond to patch boundaries.

In determining the value of the patch video syntax, the value may be determined to be 0 if it is determined that the patch video content is not included in the input video. In contrast, the value may be determined to be 1 if it is determined that the patch video content is included in the input video.

In the determining whether the patch video content is included, source information of the input video may be identified to determine whether the patch video content is included in the input video.

According to another embodiment of a first aspect of the present disclosure, a method for decoding a video comprises: receiving encoded video data; determining a value of a patch video syntax indicating whether patch video content containing a patch is included in an input video corresponding to the encoded video data; and decoding the encoded video data based on the encoded video data and the value of the patch video syntax.

The method may further comprise determining whether the patch video content is included in the input video based on the value of the patch video syntax.

In the determining, it may be determined that the patch video content is not included in the input video if the value of the patch video syntax is 0, and that the patch video content is included if the value is 1.

If it is determined that the patch video content is included in the input video, the decoding may comprise decoding the encoded video data based on at least one of: removing an extended area of the patch, or not applying a DBF to block boundaries that correspond to patch boundaries.

The method may further comprise playing back the decoded video data. If it is determined that the patch video content is included in the input video, only a partial area of the area corresponding to the patch may be played back.

According to yet another embodiment of a first aspect of the present disclosure, a method of preprocessing a video may comprise: determining whether patch video content including a patch is included in the input video; and extending an area corresponding to the patch if it is determined that the patch video content is included.

In the extending, the area corresponding to the patch may be extended by a predetermined pixel unit in each of the top, bottom, left, and right directions.

In the extending, the area may be extended by a predetermined ratio with respect to the area corresponding to the patch, in each of the top, bottom, left, and right directions.

In the extending, the area may be extended based on pixel values of pixels located at the boundary of the area corresponding to the patch.

The method may further comprise determining a value of an extension syntax indicating whether the area corresponding to the patch has been extended.

In the determining, if the area corresponding to the patch has not been extended, the value of the extension syntax may be determined to be 0. If the area has been extended, the value may be determined to be 1.

The method may further comprise generating and outputting a bitstream based on the input video and the value of the extension syntax.

According to still another embodiment of the first aspect of the present disclosure, a method of decoding a video may comprise: receiving encoded video data; determining a value of an extension syntax indicating whether an area corresponding to a patch included in an input video corresponding to the encoded video data has been extended; and decoding the encoded video data based on the encoded video data and the value of the extension syntax.

The decoding may comprise determining whether to remove the extended area based on the value of the extension syntax.

In the determining, if the value of the extension syntax is 1, the extended area may be removed.

According to an embodiment of a second aspect of the present disclosure, a video encoding apparatus comprises: a memory to store computer-executable instructions; and a processor configured to execute the instructions to perform a method comprising: determining whether patch video content including a patch is included in an input video; and determining a value of a patch video syntax indicating whether the patch video content is included in the input video, based on the result of the determining.

According to another embodiment of the second aspect, a video decoding apparatus comprises: a memory to store computer-executable instructions; and a processor configured to execute the instructions to perform a method comprising: receiving encoded video data; determining a value of a patch video syntax indicating whether patch video content is included in an input video corresponding to the encoded video data; and decoding the encoded video data based on the encoded video data and the value of the patch video syntax.

According to a third aspect of the present disclosure, a non-transitory computer-readable storage medium storing computer-executable instructions. When executed by a processor, the instructions cause the processor to perform a method comprising: determining whether patch video content including a patch is included in an input video; and determining a value of a patch video syntax indicating whether the patch video content is included in the input video, based on the result of the determining.

According to a fourth aspect of the present disclosure, a computer program stored on a non-transitory computer-readable storage medium including instructions that, when executed by a processor, cause the processor to perform a method comprising: determining whether patch video content including a patch is included in an input video; and determining a value of a patch video syntax indicating whether the patch video content is included in the input video, based on the result of the determining.

### Advantageous Effects

According to the present invention, it may be possible to provide a method of signaling whether a video to be encoded and decoded is a patch video. In addition, it may be possible to provide a method of encoding and decoding an image so that boundaries between patches do not become blurred.

In addition, according to the present invention, when encoding a video, by signaling whether the video is a patch video or an intact video, and not applying DBF when a boundary between blocks matches a boundary between patches, encoding efficiency may be improved and quality of a restored image may be enhanced.

It is to be understood that the advantages described above are not intended to be limiting, and additional advantages and features will be apparent to those skilled in the art from the following detailed description. Such advantages are considered to be within the scope of the present disclosure.

### DESCRIPTION OF DRAWINGS

FIG. 1 is an exemplified diagram illustrating a comparison between an image before and after applying a deblocking filter (DBF).

FIG. 2 is an exemplified diagram comparing a structure of a conventional camera and a plenoptic camera.

FIG. 3 is an exemplified diagram illustrating a preprocessing process in which each micro image (MI) of a plenoptic video is cut into rectangular patches, and the cut patches are concatenated.

FIG. 4 is an exemplified diagram illustrating discontinuity between patches in a plenoptic video that has undergone a preprocessing process according to FIG. 3.

FIG. 5 is an exemplified diagram illustrating an attribute atlas generated through a pruning process performed by an MIV encoder.

FIG. 6A is an exemplified diagram illustrating a picture, a sequence, and a slice. Definitions of picture, sequence, and slice used in the present specification are as follows.

FIG. 6B is an exemplified diagram illustrating a case in which pictures, which are intact video content and pictures, which are patch video content are mixed in a video to be encoded.

FIG. 6C is an exemplified diagram illustrating a case in which a slice, which is intact video content and a slice, which is patch video content are mixed in a picture to be encoded.

FIG. 7 is an exemplified diagram illustrating an operation of an encoder that signals to a decoder whether an image to be encoded is a video composed of patches, according to an embodiment of the present invention.

FIG. 8 is an exemplified diagram illustrating an operation of a decoder that recognizes, through a bitstream, whether an image to be decoded is a video composed of patches, according to an embodiment of the present invention.

FIG. 9 is an exemplified diagram illustrating syntax added according to the operation of the encoder of FIG. 7 and the operation of the decoder of FIG. 8.

FIG. 10 is an exemplified diagram illustrating a preprocessing operation of extending and concatenating an outside of a patch area for patch video generation, according to an embodiment of the present invention.

FIG. 11 is an exemplified diagram illustrating various methods of extending an outside of a patch area.

FIG. 12 is an exemplified diagram illustrating a position where a syntax element pdu_spare_flag is added in a PDU (patch data unit) stage.

FIG. 13 is an exemplified diagram illustrating a case where pdu_2d_pos_x and pdu_2d_pos_y indicate coordinates of a patch before extension, and pdu_2d_size_x_minus_1 and pdu_2d_size_y_minus_1 indicate a size of the patch before extension.

FIG. 14 is an exemplified diagram illustrating a case in which pdu_2d_pos_x and pdu_2d_pos_y indicate coordinates of a patch before extension, pdu_2d_size_x_minus_1 and pdu_2d_size_y_minus_1 indicate a size of an extended patch, and thicknesses of top and bottom sides of the extended area are the same, and thicknesses of left and right sides are the same, and syntax added in a PDU stage accordingly.

FIG. 15 is an exemplified diagram illustrating a case in which pdu_2d_pos_x and pdu_2d_pos_y indicate coordinates of a patch before extension, pdu_2d_size_x_minus_1 and pdu_2d_size_y_minus_1 indicate a size of an extended patch, and thicknesses of top, bottom, left, and right sides of the extended area are different, and syntax added in a PDU stage accordingly.

FIG. 16 is an exemplified diagram illustrating a case in which pdu_2d_pos_x and pdu_2d_pos_y indicate coordinates of an extended patch, and pdu_2d_size_x_minus_1 and pdu_2d_size_y_minus_1 indicate a size of a patch before extension, and a case in which pdu_2d_size_x_minus_1 and pdu_2d_size_y_minus_1 indicate a size of an extended patch.

FIG. 17 is an exemplified diagram illustrating a case in which thicknesses of top and bottom sides of an extended area are the same, and thicknesses of left and right sides are the same, and a case in which thicknesses of top, bottom, left, and right sides of an extended area are different.

FIG. 18 is an exemplified diagram illustrating an operation of removing an extended area outside a patch, for an operation (a selective patch video playback operation) of playing back only a selected area from decoded patch video data, according to an embodiment of the present invention.

FIG. 19 and FIG. 20 are exemplified diagrams illustrating syntax added for an operation (a selective DBF application operation) of adjusting an encoder and a decoder in order not to apply DBF to boundaries between blocks corresponding to boundaries between patches, according to an embodiment of the present invention.

FIG. 21 is an exemplified diagram illustrating a structure of syntax that is changed when the uniform_patch_size_flag is 0, in the operation of FIG. 20.

FIG. 22 and FIG. 23 are exemplified diagrams illustrating a process of determining a position of each patch when the uniform_patch_size_flag is 1 in the operation of FIG. 20.

FIG. 24 is a flowchart illustrating an operation of skipping a DBF process at a boundary between patches that coincides with a boundary between blocks.

FIG. 25 is a flowchart illustrating an operation of setting a value of BS to 0 at a boundary between patches that coincides with a boundary between blocks.

FIG. 26 is a graph illustrating mapping a larger value of β than in the related art to an average value of quantization parameters (QP) of two blocks that touch a boundary, when a boundary between patches coincides with a boundary between blocks.

FIG. 27 is an exemplified diagram of an apparatus for performing a video encoding method performing an overall operation according to the present invention.

FIG. 28 is a diagram illustrating that the video encoding and decoding method according to the present invention preserves boundaries between patches better than the related art.

FIG. 29 is a flowchart exemplarily illustrating a video encoding method according to an embodiment of a first aspect of the present invention.

FIG. 30 is a flowchart exemplarily illustrating a video preprocessing method according to another embodiment of the first aspect of the present invention.

FIG. 31 is a block diagram exemplarily illustrating a video encoding apparatus according to an embodiment of a second aspect of the present invention.

FIG. 32 is a block diagram exemplarily illustrating functions of a video encoding program.

FIG. 33 is a flowchart exemplarily illustrating a video decoding method according to an embodiment of a first aspect of the present invention.

FIG. 34 is a flowchart exemplarily illustrating a video decoding method according to another embodiment of the first aspect of the present invention.

FIG. 35 is a block diagram exemplarily illustrating a video decoding apparatus according to an embodiment of a second aspect of the present invention.

FIG. 36 is a block diagram exemplarily illustrating functions of a video decoding program.

### DETAILED DESCRIPTION OF THE INVENTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

In describing embodiments of the present invention, if it is considered that a detailed description of a known function or configuration may unnecessarily obscure the gist of the present invention, the detailed description will be omitted. In addition, the terms described below are terms defined in consideration of functions in the embodiments of the present invention, the terms may vary according to the intention or precedent of a technician working in the field, the emergence of new technologies, and the like. Therefore, the terms used in the present disclosure should be defined based on the meaning of the terms and the overall contents of the present disclosure, not just the name of the terms.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure.

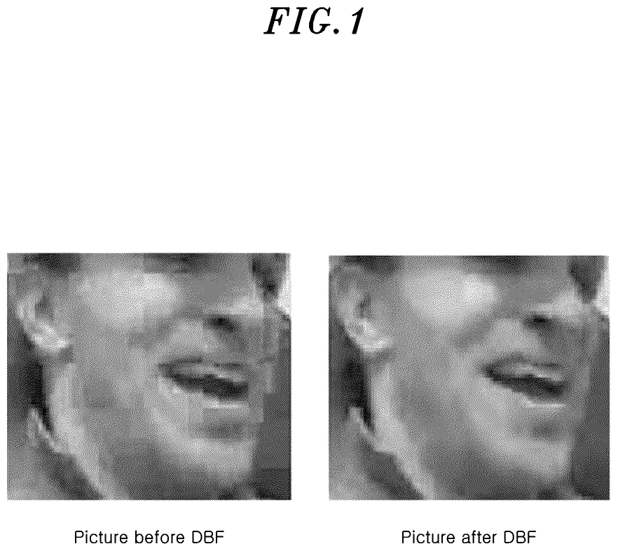

FIG. 1 is an exemplified diagram illustrating a comparison between an image before and after applying a deblocking filter (DBF).

A conventional video codec such as HEVC or VVC may apply a deblocking filter (DBF) to a restored picture in order to reduce blocking artifacts occurred by discontinuity between pixel values at boundaries between blocks, because prediction and restoration are performed in block units. In this case, a size and a dimension of a block may be determined based on encoding information of a video. In addition, based on the size and dimension of the block, a two-dimensional coordinate value of a block in a picture may be determined. A restored picture may be stored in a decoded picture buffer (DPB) and may be used as a reference when another picture performs inter-picture prediction. Therefore, as illustrated in FIG. 1, when blocking artifacts are removed through DBF before the restored picture is stored in DPB, an encoder and a decoder may perform inter-picture prediction more accurately.

FIG. 2 is an exemplified diagram comparing a structure of a conventional camera and a plenoptic camera.

As illustrated in FIG. 2, a plenoptic camera may include a micro lens array (MLA) that allows light rays traveling in different directions from one position of a subject to be incident on each different light-receiving pixel on an image sensor.

An image that each micro lens forms on the sensor of the plenoptic camera is referred to as a micro image (MI). In addition, a boundary area in each MI constituting plenoptic video data is referred to as an intra-MI boundary area, and pixels positioned in the intra-MI boundary area are referred to as intra-MI boundary area pixels. In this case, vignetting artifacts may occur in the intra-MI boundary area pixels.

An area between an MI and other MIs in its neighborhood is referred to as an inter-MI area, and pixels positioned in the inter-MI area are referred to as inter-MI area pixels. In this case, in the inter-MI area, light rays that have passed through a micro lens may not reach or may be insufficient in intensity, so the inter-MI area pixels may not be used in application tasks of plenoptic video such as viewpoint rendering or refocusing. Therefore, before the plenoptic video is encoded, a preprocessing process may be performed in which a rectangular area inside each MI is cut into patches, excluding pixels in the intra-MI boundary area and the inter-MI area, and then the cut patches are concatenated so that encoding may be performed.

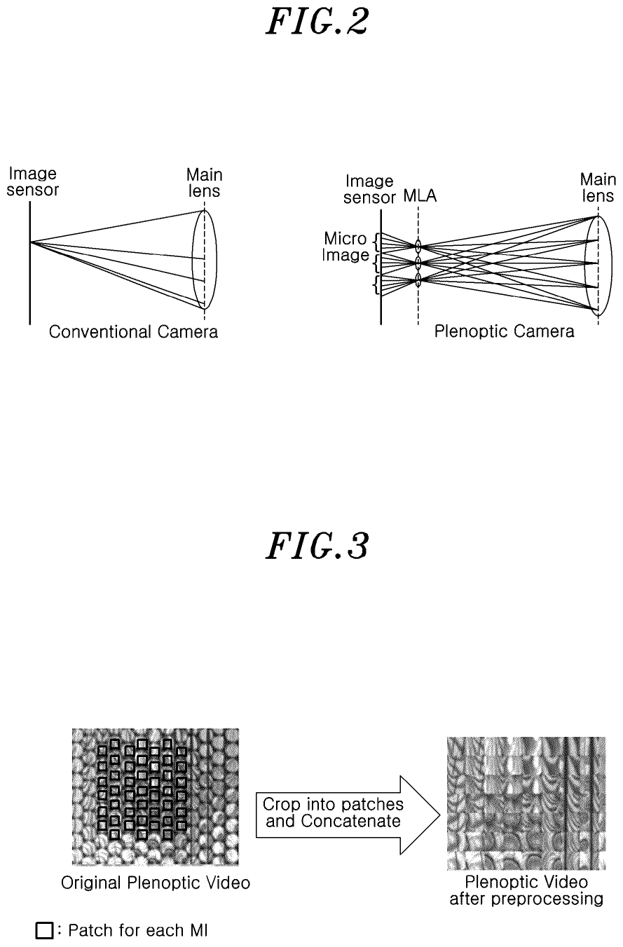

FIG. 3 is an exemplified diagram illustrating a preprocessing process in which each micro image (MI) of a plenoptic video is cut into rectangular patches, and the cut patches are concatenated.

A patch may refer to one of image pieces concatenated to form a video to be encoded by a codec, or to configure a plurality of feature sets.

For example, in a plenoptic video, as illustrated in FIG. 3, a predetermined area in each micro image may be cut into a rectangular size not exceeding the diameter of each MI (this operation is referred to as cropping operation), and the cut pieces may be concatenated (this operation is referred to as concatenating operation) to generate each picture, and the pictures may be collected to form a video sequence. In this case, the cropping operation and the concatenating operation together are referred to as preprocessing. Therefore, in a plenoptic video, a predetermined cropped area in each MI may be referred to as a patch.

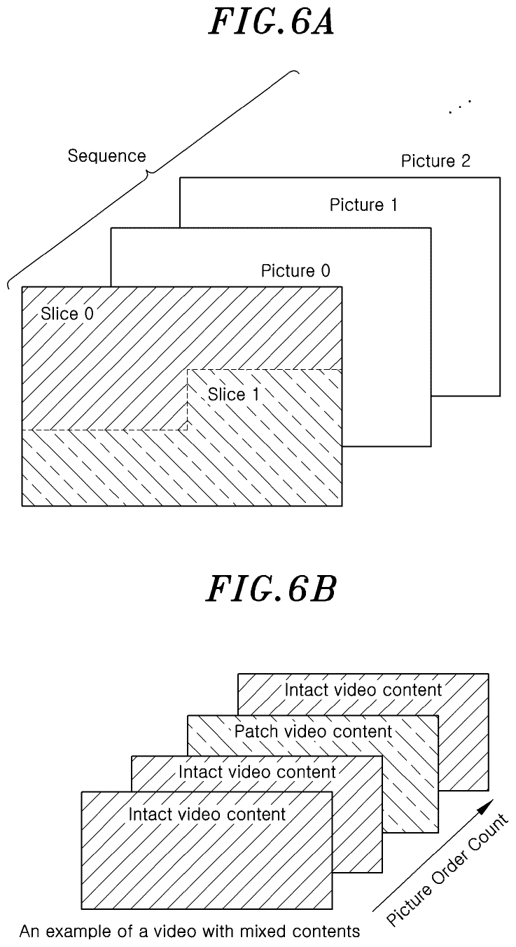

As another example, in MIV, as illustrated in FIG. 5, an atlas may be generated through a process in which additional views among source views to be encoded are divided into rectangular shapes, and rectangles that do not overlap with a basic view are concatenated to the basic view, and the generated atlas may be encoded through a conventional video compression standard such as HEVC or VVC. A rectangular image area used in such a process may be referred to as a patch.

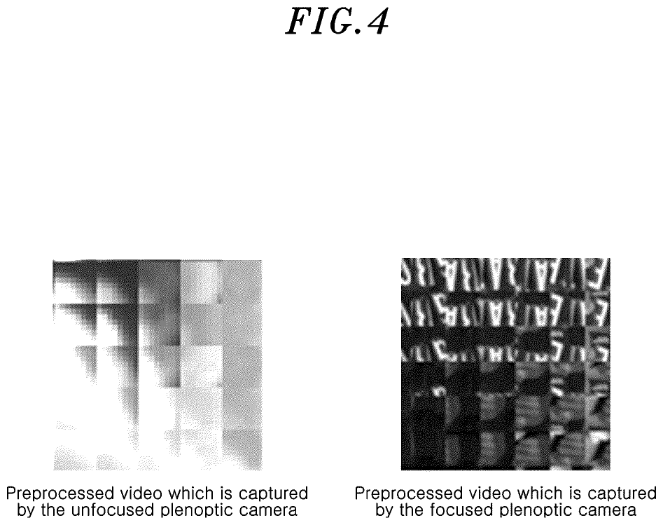

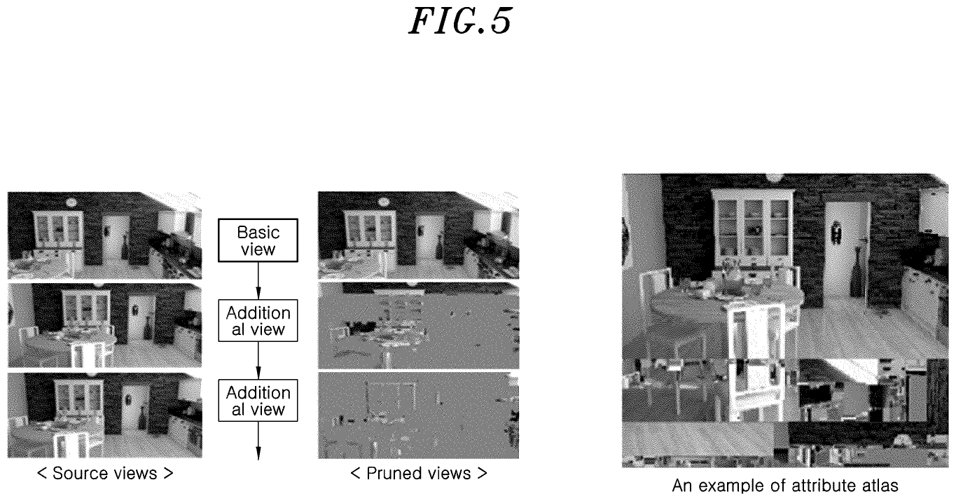

FIG. 4 is an exemplified diagram illustrating discontinuity between patches in a plenoptic video that has undergone a preprocessing process according to FIG. 3.

Due to patches generated through the preprocessing process according to FIG. 3, discontinuity of pixel values between patches in a plenoptic video may occur, as in FIG. 4.

FIG. 5 is an exemplified diagram illustrating an attribute atlas generated through a pruning process performed by an MIV encoder.

Since the atlas of MIV is formed by concatenating patches cut at different sizes and positions from different views, discontinuity may occur between patches as in FIG. 5.

FIG. 6A is an exemplified diagram illustrating a picture, a sequence, and a slice. Definitions of picture, sequence, and slice used in the present specification are as follows.

A picture is one element constituting a video, and means an image acquired at the same time instant in the video. In addition, a picture may mean a frame as an image included in a video.

A sequence means a set of a plurality of pictures.

A slice means a sub-divided unit of a picture.

FIG. 6B is an exemplified diagram illustrating a case in which pictures, which are intact video content and pictures, which are patch video content are mixed in a video to be encoded, and FIG. 6C is an exemplified diagram illustrating a case in which a slice, which is intact video content and a slice, which is patch video content are mixed in a picture to be encoded.

Both a plenoptic video and the atlas of MIV may undergo in common a predetermined preprocessing process of generating a patch video before being encoded by a video codec. For example, in a plenoptic video, a preprocessing process may be undergone in which the interior of an MI of each picture is cut into rectangular patches, and the patches are concatenated to generate a patch video. As another example, in an atlas of MIV, a preprocessing process may be undergone in which patches cut in rectangular shapes from additional views that do not overlap with a basic view are concatenated to the basic view to generate a patch video.

Here, a video in which a task of concatenating patches has been performed before being encoded is referred to as a patch video. In contrast, a video in which a task of concatenating patches is not performed is referred to as an intact video.

In conventional video compression technologies such as a plenoptic video or an atlas of MIV, when intact video content and patch video content are mixed and encoded in one video, as in FIGS. 6B and 6C, there is a limitation in that identification is impossible.

According to an embodiment of the present invention, it is possible to determine whether a video is a patch video by identifying source information of an input video. Specifically, when encoding a video, an argument may be added to indicate whether a current picture or slice to be encoded is intact video content or patch video content. An encoder, by reading the argument added to an input video, may recognize whether a current picture or slice being encoded is intact video content or patch video content, and may input the recognized information to a header of a picture or slice stage in a bitstream using an additional syntax element. In addition, a decoder may recognize whether the content is an intact video or a patch video by parsing a syntax element from a bitstream.

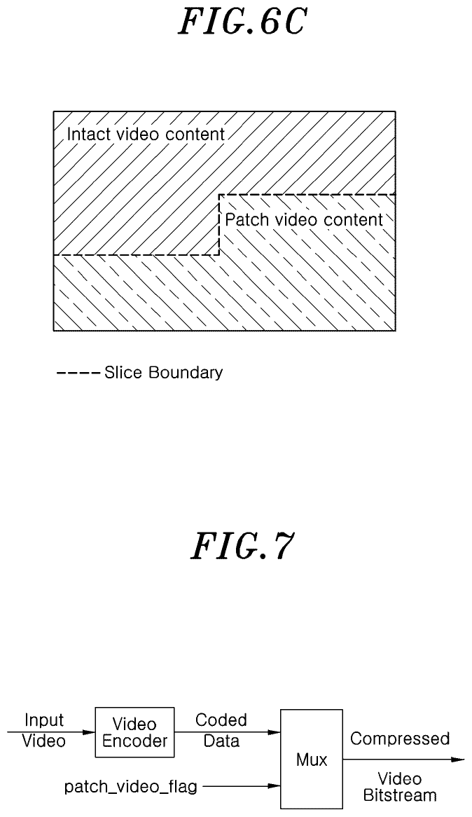

FIG. 7 is an exemplified diagram illustrating an operation of an encoder that signals to a decoder whether an image to be encoded is a video composed of patches, according to an embodiment of the present invention.

An encoder may signal, using a specific syntax element (e.g., patch_video_flag), whether a currently encoded video is a patch-based video, in various higher stages such as sequence parameter set (SPS), video parameter set (VPS), picture parameter set (PPS), picture header (PH), or slice header (SH). For example, when the patch_video_flag is 1, it may mean that the currently encoded video is a patch-based video, and when the patch_video_flag is 0, it may mean that the currently encoded video is an intact video.

An encoder may signal, in an SPS or VPS stage, whether a currently encoded sequence is a patch video.

In addition, an encoder may signal, in a PPS or PH stage, whether a currently encoded picture is a patch video.

In addition, an encoder may signal, in an SH stage, whether a currently encoded slice is a patch video.

A position and a manner in which the corresponding syntax is signaled may be known with reference to FIG. 9.

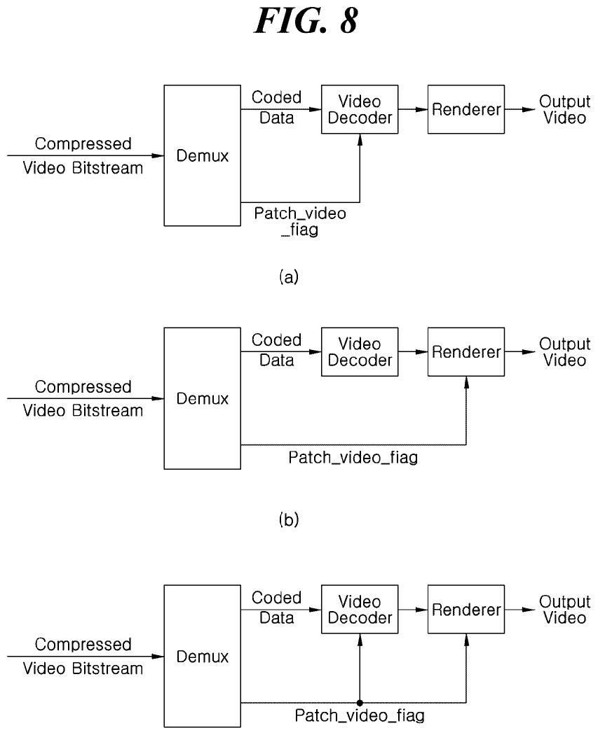

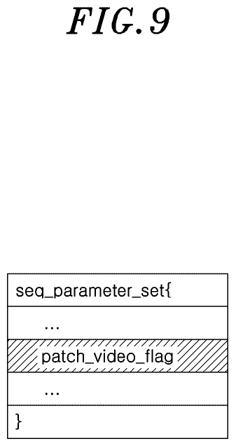

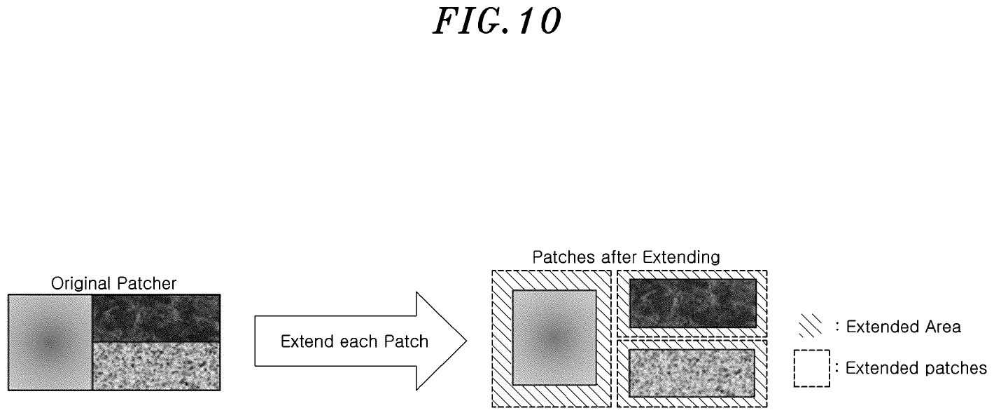

FIGS. 8A, 8B, and 8C are an exemplified diagram illustrating an operation of a decoder that recognizes, through a bitstream, whether an image to be decoded is a video composed of patches, according to an embodiment of the present invention.

A decoder may recognize whether a currently decoded video is a patch video by parsing a specific syntax element (e.g., patch_video_flag) in various higher stages such as SPS, VPS, PPS, PH, or SH. For example, when the patch_video_flag is 1, it may mean that the currently encoded video is a patch-based video, and when the patch_video_flag is 0, it may mean that the currently encoded video is an intact video.

A decoder may parse, in an SPS or VPS stage, whether a currently decoded sequence is a patch video.

In addition, a decoder may parse, in a PPS or PH stage, whether a currently decoded picture is a patch video.

In addition, a decoder may parse, in an SH stage, whether a currently decoded slice is a patch video.

A position and a manner in which the corresponding syntax is signaled may be known with reference to FIG. 9.

A decoder may control playback of a current video based on a value of a parsed syntax element (e.g., patch_video_flag).

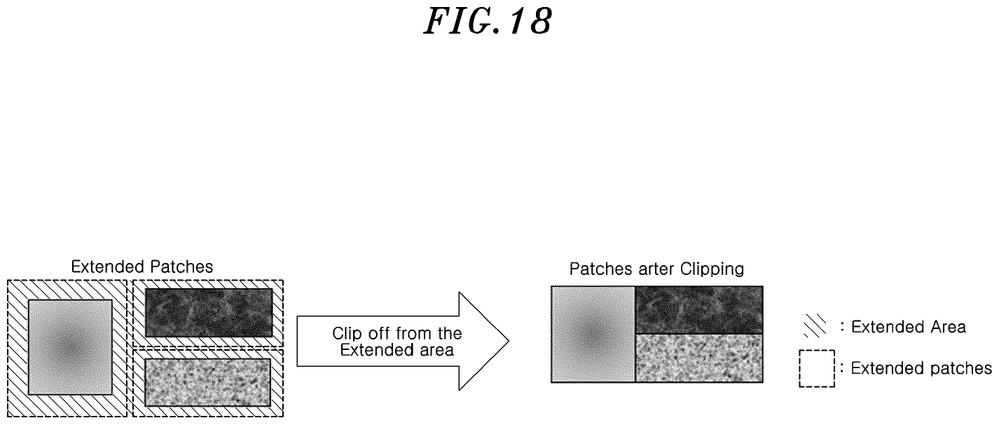

The patch_video_flag may control a decoder (video decoder) so that a patch video is played back, as in FIG. 8A. When the patch_video_flag is 1, since a currently decoded video is a patch video, the decoder may decode the video in accordance with characteristics of a patch video. In contrast, when the patch_video_flag is 0, since a currently decoded video is an intact video, the decoder may decode the video according to a method of a conventional codec such as HEVC or VVC. Here, “decode the video according to a method of a conventional codec” may mean decoding the video according to an operation method of a conventional codec such as HEVC or VVC. In addition, “decode in accordance with characteristics of a patch video” may mean an operation of removing an extended area outside a patch or not applying DBF to boundaries between blocks corresponding to boundaries between patches, for an operation (a selective patch video playback operation) that plays back only a selected area from decoded patch video data, as illustrated in FIGS. 18 to 26. That is, it may refer to modifications that may differ from an operation method of a conventional codec, but the above description is merely an example and is not limited thereto.

The patch_video_flag may control a renderer so that a patch video is played back, as in FIG. 8B. When the patch_video_flag is 1, since a currently decoded video is a patch video, the renderer may play back a video restored by the decoder in accordance with characteristics of the patch video. In contrast, when the patch_video_flag is 0, since a currently decoded video is an intact video, the renderer may play back a video restored by the decoder in accordance with characteristics of the intact video.

The patch_video_flag may control both a decoder and a renderer so that a patch video is played back, as in FIG. 8C. When the patch_video_flag is 1, since a currently decoded video is a patch video, the decoder may decode a current video in accordance with characteristics of a patch video, and the renderer may play back a decoded video in accordance with characteristics of a patch video. In contrast, when the patch_video_flag is 0, since a currently decoded video is an intact video, the decoder may decode the current video in accordance with characteristics of an intact video, and the renderer may play back a decoded video in accordance with characteristics of the intact video.

FIG. 9 is an exemplified diagram illustrating syntax added according to the operation of the encoder of FIG. 7 and the operation of the decoder of FIGS. 8A, 8B, and 8C.

FIG. 9 illustrates a case of a sequence parameter set (SPS), but the added syntax may be similarly implemented in VPS, PPS, PH, and SH stages, in addition to the SPS.

FIG. 10 is an exemplified diagram illustrating a preprocessing operation of extending and concatenating an outside of a patch area for patch video generation, according to an embodiment of the present invention.

In order to prevent DBF from removing discontinuity at patch boundaries, an encoder may undergo a preprocessing process of extending an outside of each patch area by a predetermined thickness and then concatenating them to generate a patch video.

As illustrated in FIG. 10, when DBF is applied to a patch video composed of extended patches, since original patches before the extension are positioned at a predetermined interval due to the extended area, it is possible to prevent a case in which discontinuity at boundaries between patches is removed by DBF.

11A, 11B, 11C, and 11D are an exemplified diagram illustrating various methods of extending an outside of a patch area. In a plenoptic video, an extended patch may be generated through various methods as illustrated in 11A, 11B, 11C, and 11D.

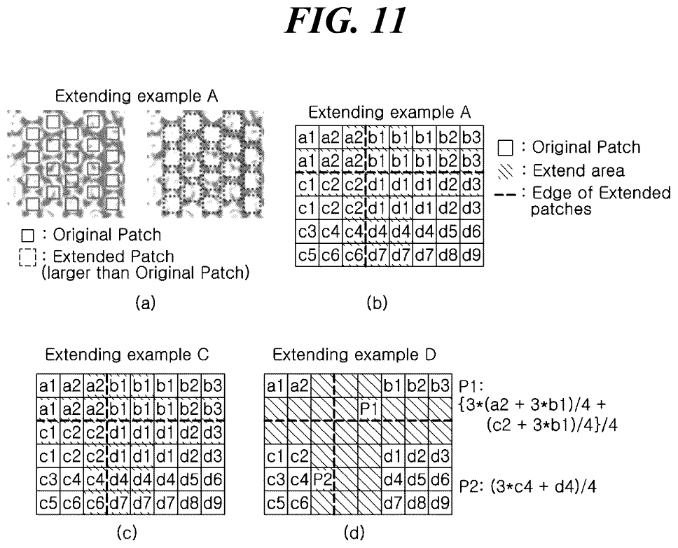

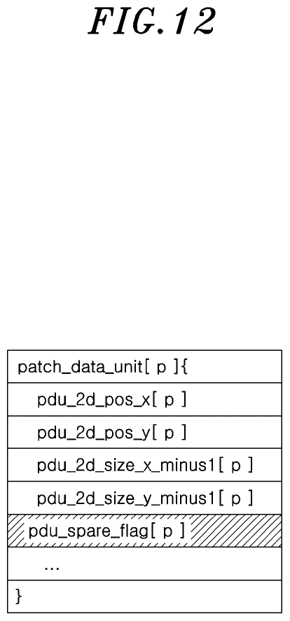

As illustrated in FIG. 11A, an encoder may extend an outside of a patch area before extension by selecting an area larger than a patch before extension. Specifically, in a plenoptic video, when extending a patch before extension by an extension method of FIG. 11A, in determining a size of an extended patch, an encoder may extend an outside of a patch area before extension by selecting an area larger than the patch before extension through a method of selecting a maximum size of inscribed square by receiving a diameter of each MI as input or applying a predetermined ratio of the diameter (e.g., 25%).

In addition, as illustrated in FIG. 11B, an encoder may extend an outside of a patch area before extension by copying pixel values of a patch before extension that is closest to a point in an area to be extended.

In addition, as illustrated in FIG. 11C, an encoder may extend an outside of a patch area before extension by mirroring a row or column of adjacent patches before extension.

In addition, as illustrated in FIG. 11D, an encoder may extend an outside of a patch area before extension by performing linear interpolation of pixel values of adjacent patches before extension.

In case of MIV, an encoder may extend an outside of a patch area before extension through a method of extending each direction of top, bottom, left, and right of a patch before extension by a predetermined thickness (e.g., 4 pixels), or by a predetermined ratio (e.g., 25%) of the size of the patch before extension. The above-described methods of extending an outside of a patch area before extension are merely examples, and are not limited thereto.

An encoder, during patch video preprocessing, may set a width or height of an extended patch to be a power of 2 such as 4, 8, 16, 32. In a conventional codec such as VVC, an encoder may set a block size to be a power of 2 for hardware implementation optimization. When a boundary between patches, where discontinuity of pixel values is large, is positioned inside a block and not at a boundary between blocks, an encoder may generate non-optimal prediction information during performing intra-picture or inter-picture prediction, and a decoder may generate a predictor with the non-optimal prediction information, which may cause a large error in a restored image. Therefore, in consideration of the above-described problem, an encoder may set a width or height of an extended patch to be a power of 2.

FIG. 12 is an exemplified diagram illustrating a position where a syntax element pdu_spare_flag is added in a PDU (patch data unit) stage.

After extending a patch area, an encoder may signal information on the extended area of the patch.

First, as illustrated in FIG. 12, an encoder may signal whether a patch of a patch video is extended by using a syntax element (e.g., pdu_spare_flag). In this case, when pdu_spare_flag is 1, it may mean that the patch of the currently encoded patch video is extended, and when it is 0, it may mean that the patch is not extended.

Next, when pdu_spare_flag is 1, depending on what positions are indicated by pdu_2d_pos_x and pdu_2d_pos_y, and what sizes are indicated by pdu_2d_size_x_minus_1 and pdu_2d_size_y_minus_1, a method of signaling syntax related to a size of an extended area by an encoder may differ.

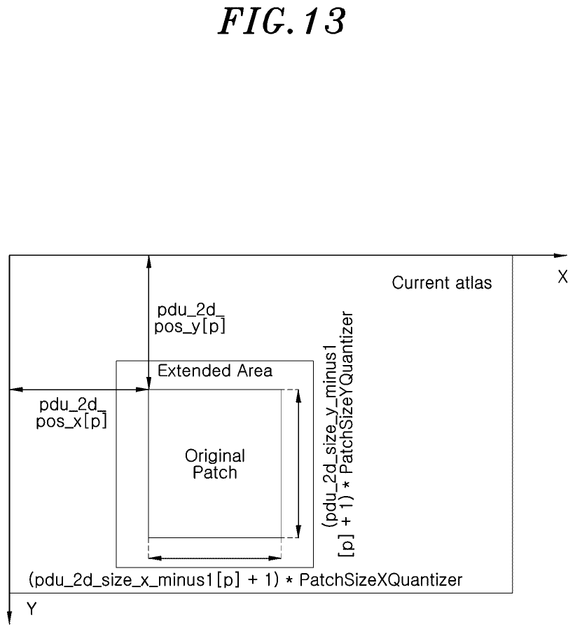

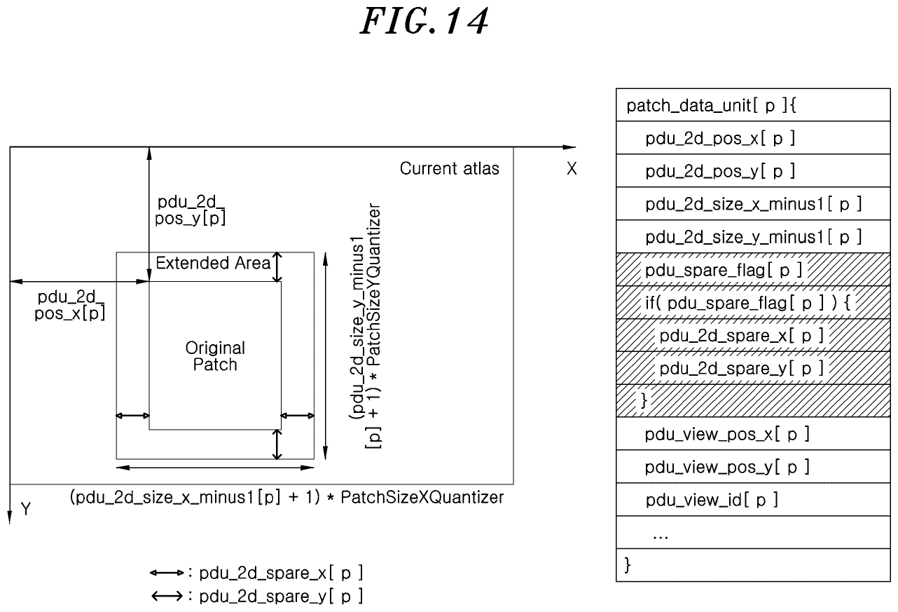

FIG. 13 is an exemplified diagram illustrating a case where pdu_2d_pos_x and pdu_2d_pos_y indicate coordinates of a patch before extension, and pdu_2d_size_x_minus_1 and pdu_2d_size_y_minus_1 indicate a size of the patch before extension.

As illustrated in FIG. 13, when pdu_2d_pos_x and pdu_2d_pos_y indicate coordinates of a patch before extension, and pdu_2d_size_x_minus_1 and pdu_2d_size_y_minus_1 indicate a size of the patch before extension, an encoder may not signal a thickness of an extended area.

FIG. 14 is an exemplified diagram illustrating a case in which pdu_2d_pos_x and pdu_2d_pos_y indicate coordinates of a patch before extension, pdu_2d_size_x_minus_1 and pdu_2d_size_y_minus_1 indicate a size of an extended patch, and thicknesses of top and bottom sides of the extended area are the same, and thicknesses of left and right sides are the same, and syntax added in a PDU stage accordingly.

As illustrated in FIG. 14, when pdu_2d_pos_x and pdu_2d_pos_y indicate coordinates of a patch before extension, pdu_2d_size_x_minus_1 and pdu_2d_size_y_minus_1 indicate a size of an extended patch, and thicknesses of top and bottom sides of the extended area are the same, and thicknesses of left and right sides are the same, an encoder may signal a thickness of each direction by using syntax elements (e.g., pdu_2d_spare_x, pdu_2d_spare_y).

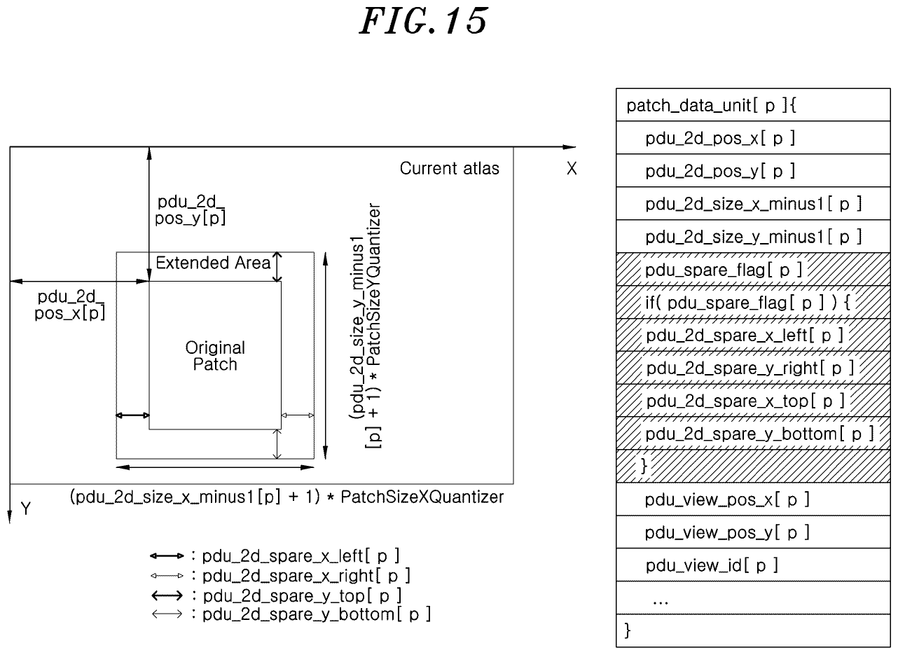

FIG. 15 is an exemplified diagram illustrating a case in which pdu_2d_pos_x and pdu_2d_pos_y indicate coordinates of a patch before extension, pdu_2d_size_x_minus_1 and pdu_2d_size_y_minus_1 indicate a size of an extended patch, and thicknesses of top, bottom, left, and right sides of the extended area are different, and syntax added in a PDU stage accordingly.

As illustrated in FIG. 15, when pdu_2d_pos_x and pdu_2d_pos_y indicate coordinates of a patch before extension, pdu_2d_size_x_minus_1 and pdu_2d_size_y_minus_1 indicate a size of an extended patch, and thicknesses of top, bottom, left, and right sides of the extended area are different, an encoder may signal a thickness of each direction by using syntax elements (e.g., pdu_2d_spare_x_left, pdu_2d_spare_x_right, pdu_2d_spare_y_top, pdu_2d_spare_y_bottom).

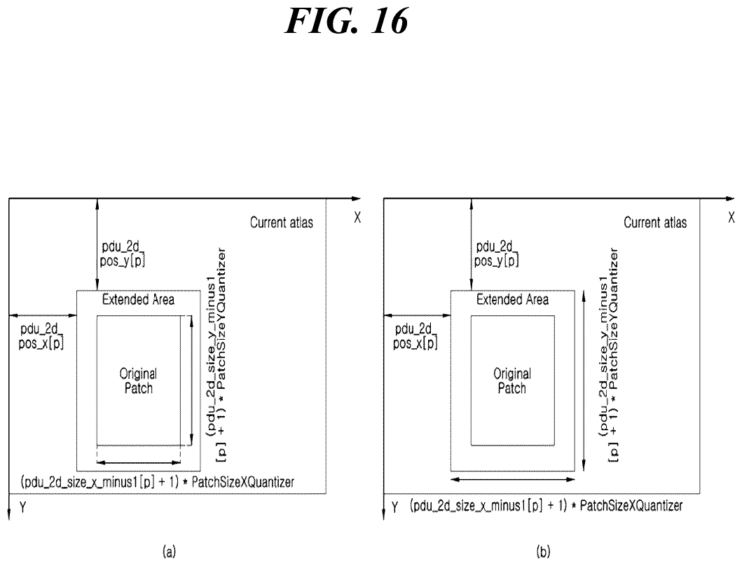

FIGS. 16A and 16B are an exemplified diagram illustrating a case in which pdu_2d_pos_x and pdu_2d_pos_y indicate coordinates of an extended patch, and pdu_2d_size_x_minus_1 and pdu_2d_size_y_minus_1 indicate a size of a patch before extension, and a case in which pdu_2d_size_x_minus_1 and pdu_2d_size_y_minus_1 indicate a size of an extended patch.

As illustrated in FIGS. 16A and 16B, when pdu_2d_pos_x and pdu_2d_pos_y indicate coordinates of an extended patch, in both cases where pdu_2d_size_x_minus_1 and pdu_2d_size_y_minus_1 indicate a size of a patch before extension, and where they indicate a size of an extended patch, an encoder may specify a size of an extended area.

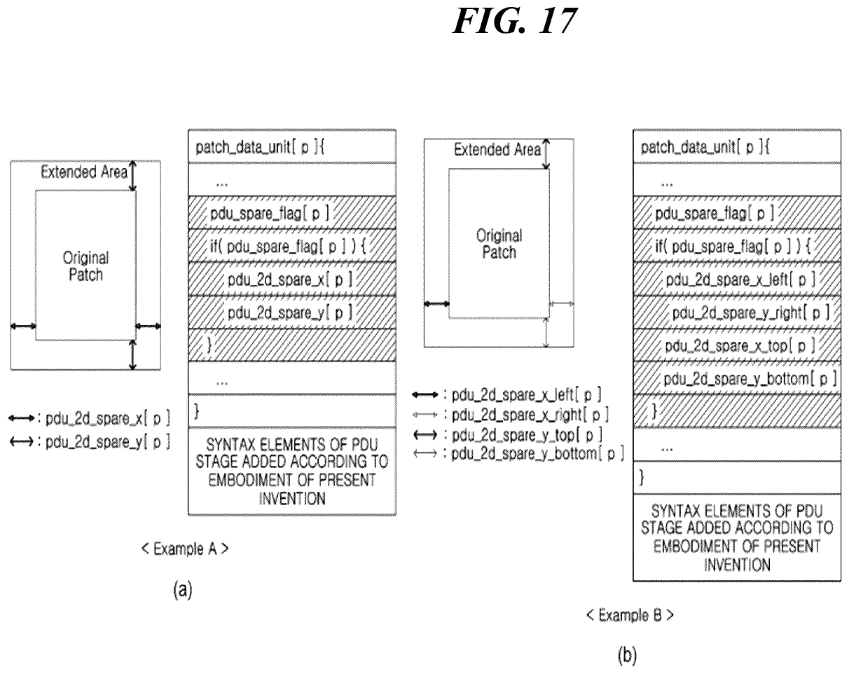

FIGS. 17A and 17B are an exemplified diagram illustrating a case in which thicknesses of top and bottom sides of an extended area are the same, and thicknesses of left and right sides are the same, and a case in which thicknesses of top, bottom, left, and right sides of an extended area are different.

As illustrated in FIG. 17A, when thicknesses of top and bottom sides of an extended area are the same, and thicknesses of left and right sides are the same, an encoder may signal a thickness of each direction by using syntax elements (e.g., pdu_spare_x, pdu_spare_y).

In addition, as illustrated in FIG. 17B, when thicknesses of top, bottom, left, and right sides of an extended area are different, an encoder may signal a thickness of each direction by using syntax elements (e.g., pdu_spare_x_left, pdu_spare_x_right, pdu_spare_y_top, pdu_spare_y_bottom).

FIG. 18 is an exemplified diagram illustrating an operation of removing an extended area outside a patch, for an operation (a selective patch video playback operation) of playing back only a selected area from decoded patch video data, according to an embodiment of the present invention.

A decoder may restore and display a patch video before extension, such as a plenoptic video or an MIV atlas, by removing an extended area from a restored patch video.

In order to recognize the extended area, a decoder may parse information related thereto from a bitstream.

First, a decoder may recognize whether the extended area should be removed from a patch of a patch video by using a syntax element (e.g., pdu_spare_flag). When the pdu_spare_flag is 1, it may mean that a patch of the currently decoded patch video is extended, and thus the extended area needs to be removed, and when the pdu_spare_flag is 0, it may mean that it is not extended. A position and a manner in which the pdu_spare_flag is parsed are as described in FIG. 12.

Next, when the pdu_spare_flag is 1, depending on what position is indicated by pdu_2d_pos_x and pdu_2d_pos_y, and what size is indicated by pdu_2d_size_x_minus_1 and pdu_2d_size_y_minus_1, a decoder may differ in a manner of parsing syntax related to a size of an extended area.

As illustrated in FIG. 13, when pdu_2d_pos_x and pdu_2d_pos_y indicate coordinates of a patch before extension, and pdu_2d_size_x_minus_1 and pdu_2d_size_y_minus_1 indicate a size of a patch before extension, a decoder may not parse a thickness of an extended area.

As illustrated in FIG. 14, when pdu_2d_pos_x and pdu_2d_pos_y indicate coordinates of a patch before extension, and pdu_2d_size_x_minus_1 and pdu_2d_size_y_minus_1 indicate a size of an extended patch, and thicknesses of top and bottom sides of the extended area are the same, and thicknesses of left and right sides are the same, a decoder may parse syntax elements (e.g., pdu_2d_spare_x, pdu_2d_spare_y) to recognize thicknesses of each direction.

As illustrated in FIG. 15, when pdu_2d_pos_x and pdu_2d_pos_y indicate coordinates of a patch before extension, and pdu_2d_size_x_minus_1 and pdu_2d_size_y_minus_1 indicate a size of an extended patch, and thicknesses of top, bottom, left, and right sides of the extended area are different, a decoder may parse syntax elements (e.g., pdu_2d_spare_x_left, pdu_2d_spare_x_right, pdu_2d_spare_y_top, pdu_2d_spare_y_bottom) to recognize thicknesses of each direction.

As illustrated in FIG. 16, when pdu_2d_pos_x and pdu_2d_pos_y indicate coordinates of an extended patch, in both cases where pdu_2d_size_x_minus_1 and pdu_2d_size_y_minus_1 indicate a size of a patch before extension, and where they indicate a size of an extended patch, a decoder may parse and recognize a size of an extended area.

As illustrated in FIG. 17A, when thicknesses of top and bottom sides of an extended area are the same, and thicknesses of left and right sides are the same, a decoder may parse syntax elements (e.g., pdu_spare_x, pdu_spare_y) to recognize thicknesses of each direction.

In addition, as illustrated in FIG. 17B, when thicknesses of top, bottom, left, and right sides of an extended area are different, a decoder may parse syntax elements (e.g., pdu_spare_x_left, pdu_spare_x_right, pdu_spare_y_top, pdu_spare_y_bottom) to recognize thicknesses of each direction.

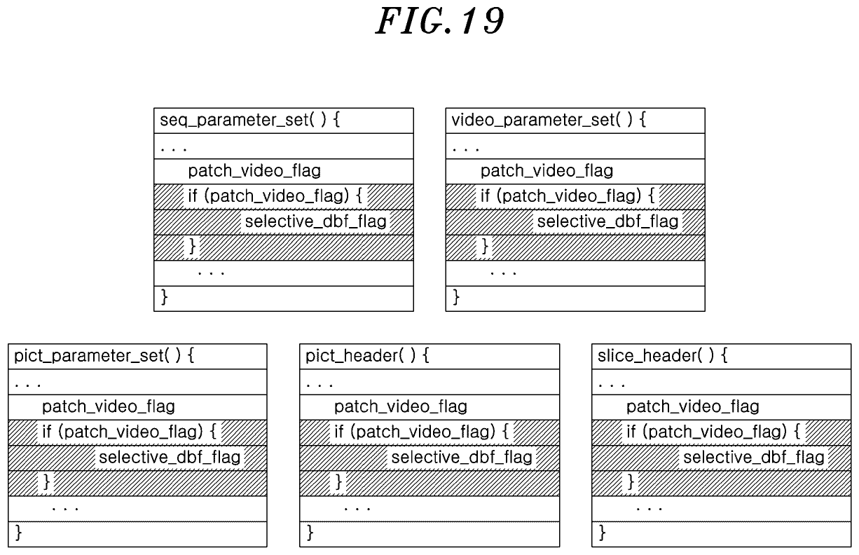

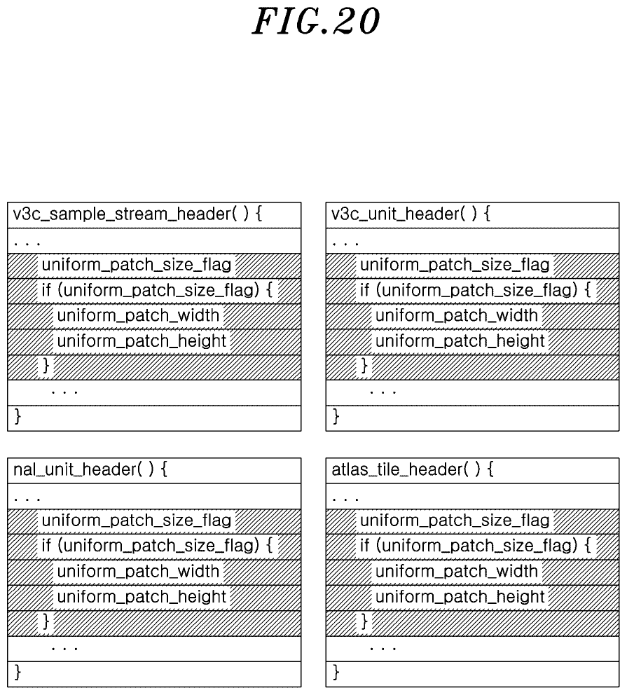

FIG. 19 and FIG. 20 are exemplified diagrams illustrating syntax added for an operation (a selective DBF application operation) of adjusting an encoder and a decoder in order not to apply DBF to boundaries between blocks corresponding to boundaries between patches, according to an embodiment of the present invention.

A selective DBF application operation according to the present invention may be signaled and parsed in various stages such as SPS, VPS, PPS, PH, and SH.

First, as illustrated in FIG. 19, when the patch_video_flag is 1, an encoder may signal whether or not to apply selective DBF according to the present invention by using selective_dbf_flag, and a decoder may parse it and recognize whether or not to apply selective DBF according to the present invention. When selective_dbf_flag is 1, an encoder or decoder may not apply DBF to a block boundary that matches a patch boundary, and when selective_dbf_flag is 0, may apply DBF to a block boundary. A size and a dimension of a block for DBF may be determined based on encoding information of a video. Specifically, based on a size and a dimension of a block, a two-dimensional coordinate value of a block in a picture may be determined. A position and a manner in which syntax to implement this is added are as illustrated in FIG. 19.

Here, positions and manners in which the selective_dbf_flag is signaled or parsed in various higher stages such as SPS, VPS, PPS, PH, and SH may be similarly implemented.

In order to apply DBF selectively according to the present invention, an encoder and a decoder may need to recognize position and size information of patches. According to whether sizes of patches constituting a patch video are uniform, a manner of signaling and parsing syntax related to size and position of a patch in a PDU stage may differ.

Next, as illustrated in FIG. 20, an encoder may signal, by using a syntax element (e.g., uniform_patch_size_flag), whether sizes of all patches in a currently encoded video are uniform, and a decoder may parse it to recognize whether patch sizes are uniform. When the uniform_patch_size_flag is 1, it may mean that sizes of patches constituting a currently encoded or decoded video are uniform, and when the uniform_patch_size_flag is 0, it may mean that patch sizes are not uniform.

In addition, as illustrated in FIG. 20, when the uniform_patch_size_flag is 1, an encoder may signal width and height of a patch by using syntax elements (e.g., uniform_patch_width, uniform_patch_height), and a decoder may parse the corresponding syntax to recognize the width and height of the patch. A position and a manner in which the corresponding syntax is signaled or parsed in higher stages of a PDU, such as v3c sample stream header, v3c_unit_header, nal_unit_header, or atlas_tile_header, may be similarly implemented.

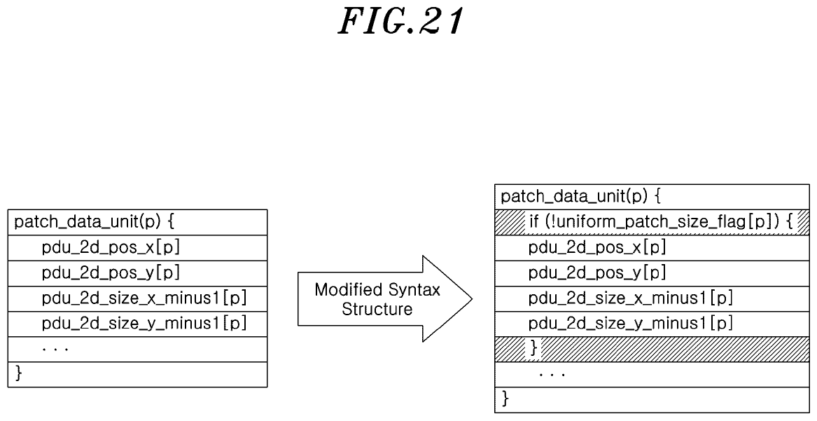

FIG. 21 is an exemplified diagram illustrating a structure of syntax that is changed when the uniform_patch_size_flag is 0, in the operation of FIG. 20.

As illustrated in FIG. 21, when the uniform_patch_size_flag is 0, an encoder may signal (x, y) position and (horizontal, vertical) size of each patch by using syntax elements in a PDU stage such as pdu_2d_pos_x, pdu_2d_pos_y, pdu_2d_size_x_minus_1, pdu_2d_size_y_minus_1, and a decoder may parse the corresponding syntax to recognize position and size information of patches. A change method of syntax structure illustrated in FIG. 21 may be implemented similarly to syntax structures of patch stages such as patch_data_unit, merge_patch_data_unit, and inter_patch_data_unit.

In the above description, names of syntax and syntax values (e.g., 0, 1) used in encoding or decoding operations are described by way of example for convenience of description, and are not limited thereto.

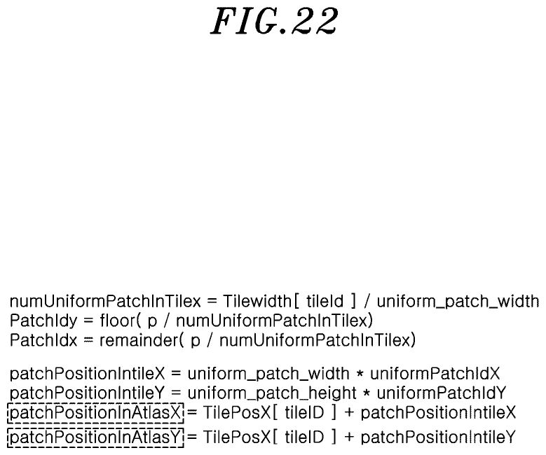

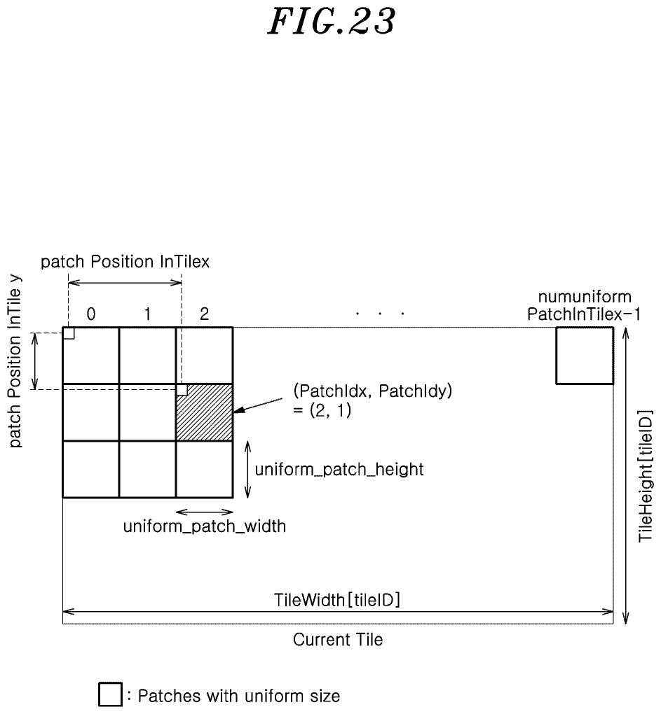

FIG. 22 and FIG. 23 are exemplified diagrams illustrating a process of determining a position of each patch when the uniform_patch_size_flag is 1 in the operation of FIG. 20.

When the uniform_patch_size_flag is 1, since uniform sizes of patches are signaled in a higher stage of the PDU, an encoder or decoder may not signal or parse size and position information of each patch in the PDU stage, as in FIG. 17. In this case, an encoder or decoder may calculate a position of each patch in an atlas, as illustrated in FIGS. 22 to 23, to determine the position of each patch. In FIG. 22, p indicates an index of a patch within a tile. In addition, TilePosX[tileID], TilePosY[tileID], TileWidth[tileID], and TileHeight[tileID], which are position and size of each tile, may be calculated in a stage higher than a tile.

Specifically, in order to determine how many patches exist on a horizontal side of a current tile, numUniformPatchInTileX may be calculated by dividing TileWidth by uniform_patch_width, as in the first line of the equation in FIG. 22. Next, in order to calculate x- and y-direction indices within the current tile from a patch index p, PatchIdX and PatchIdY may be calculated by taking an integer part and a remainder of p divided by numUniformPatchInTileX, respectively. Next, in order to determine x- and y-positions within the current tile of the patch having index p, patchPositionInTileX and patchPositionInTileY may be calculated by multiplying uniformPatchIdX and uniformPatchIdY by uniform_patch_width and uniform_patch_height, respectively. Finally, a position of each patch within the atlas may be determined by adding TilePosX and TilePosY, which are positions of a current tile within the atlas.

Thereafter, an encoder or a decoder may identify whether boundaries between blocks of a patch-based video to be encoded or decoded coincide with boundaries between patches, and may not apply DBF at the corresponding boundaries.

FIG. 24 is a flowchart illustrating an operation of skipping a DBF process at a boundary between patches that coincides with a boundary between blocks.

As illustrated in FIG. 24, when a boundary between patches coincides with a boundary between blocks, the encoder or decoder may operate such that a deblock filtering process is not performed.

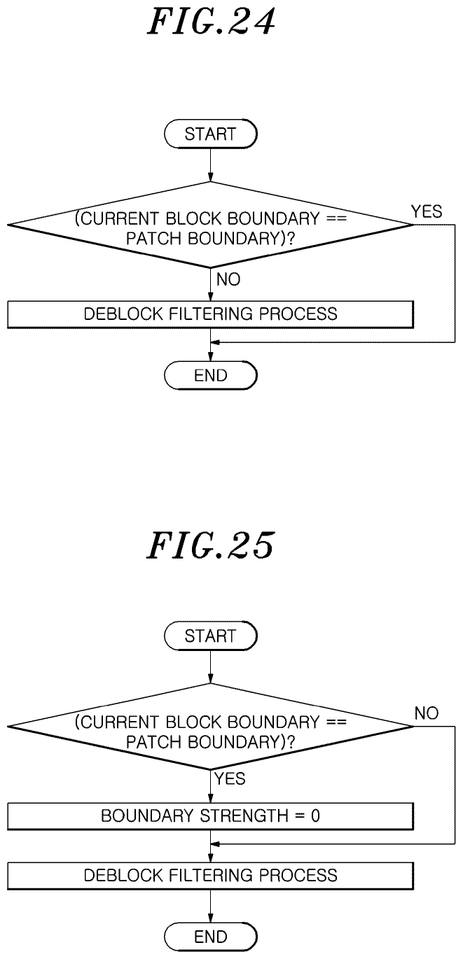

FIG. 25 is a flowchart illustrating an operation of setting a value of BS to 0 at a boundary between patches that coincides with a boundary between blocks.

As illustrated in FIG. 25, when a boundary between patches coincides with a boundary between blocks, the encoder or decoder may operate such that the value of boundary strength (BS) is set to 0, so that a subsequent deblock filtering process is not performed.

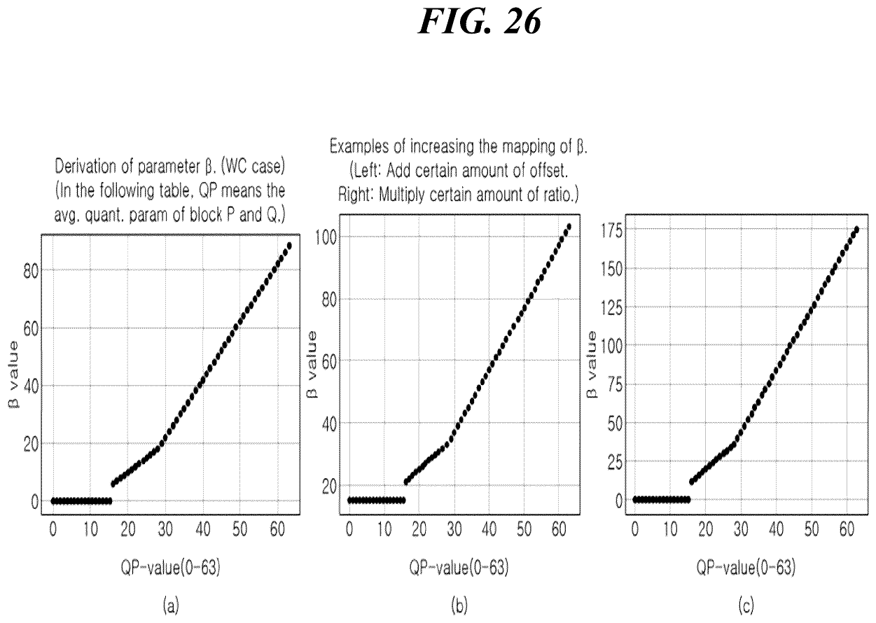

FIGS. 26A, 26B, and 26C are a graph illustrating mapping a larger value of β than in the related art to an average value of quantization parameters (QP) of two blocks that touch a boundary, when a boundary between patches coincides with a boundary between blocks.

When a boundary between patches coincides with a boundary between blocks, the encoder or decoder may map a larger value of β than in the related art to the average value of quantization parameters (QP) of two blocks that touch the boundary. At a boundary between patches, a discontinuity of pixel values may occur more significantly than in a non-patch video, and thus, when the value of β, where the average of the QP values of two blocks sticking together at a boundary is mapped, to the average of QP between two blocks that touch the boundary is increased, the deblock filtering process may not occur at the corresponding boundary.

A conventional codec clips qP (the average value of quantization parameters (QP) of two blocks in contact at a block boundary) to a value between 0 and 63, as in Equation 1 below (the clipped value is denoted as Q), and then calculates a β value corresponding to Q using a predetermined mapping relational equation.

$$Q = Clip 3 ( 0 , 63 , qP ) \qquad Equation 1$$

A graph illustrated in FIG. 26A represents a relationship between Q and β used in conventional VVC.

According to the present invention, when a picture or slice currently being encoded or decoded is patch video content, the encoder or decoder may add a predetermined positive offset to qP as in Equation 2. That is, as illustrated in FIG. 26B, the encoder or decoder according to the present invention may enable a larger value of β than in the related art to be mapped to qP.

$$Q = Clip 3 ( 0 , 63 , qP + qpOffset ) \qquad Equation 2$$

For example, the encoder or decoder may use a predetermined value such as 10 or 20 as a value of the offset, or may use a value signaled and parsed in a higher stage such as a slice or picture. At a boundary between patches, since a discontinuity of pixel values may appear more significantly than at non-boundaries between patches, when a value of β, where the average of the QP values of two blocks sticking together at a boundary is mapped, is increased, the DBF process may not occur at the corresponding boundary.

As another example, when a sequence, picture, or slice currently being encoded or decoded is patch video content, the encoder or decoder may multiply a predetermined ratio to β where the average of the QP values of two blocks sticking together at a boundary is mapped, as illustrated in FIG. 26C.

The above-described method of skipping the deblock filtering process occurring at a boundary between patches coinciding with a boundary between blocks is merely an example, and is not limited to the above-described examples.

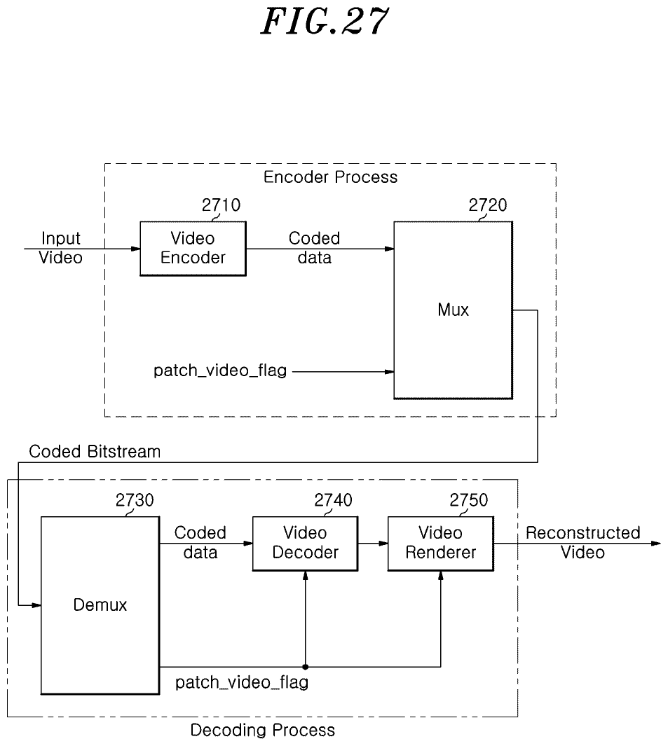

FIG. 27 is an exemplified diagram of an apparatus for performing a video encoding method performing an overall operation according to the present invention.

As illustrated in FIG. 27, an apparatus for performing video encoding and decoding methods performing the overall operation according to the present invention may include an encoder 2710 for receiving a video as input, a mux circuit 2720 for receiving encoded data and syntax as input and outputting an encoded bitstream, a demux circuit 2730 for receiving a bitstream as input and outputting encoded data and syntax, a decoder 2740 for receiving encoded data and syntax as input and outputting decoded data, and a renderer 2730 for receiving decoded data and syntax as input and outputting a restored video.

FIGS. 28A and 28B are a diagram illustrating that the video encoding and decoding method according to the present invention preserves boundaries between patches better than the related art.

FIGS. 28A and 28B illustrate a case in which a plenoptic video is encoded and decoded using the related art, and a case in which a plenoptic video is encoded and decoded using the proposed invention. As illustrated in FIGS. 28A and 28B, it may be visually seen that the video encoded and decoded through the proposed invention preserves the boundaries between patches better than the related art.

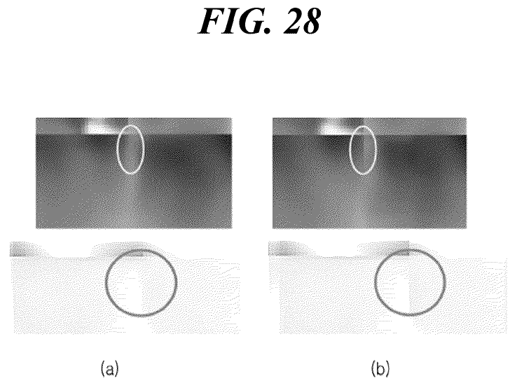

FIG. 29 is a flowchart exemplarily illustrating a video encoding method according to an embodiment of a first aspect of the present invention. Hereinafter, the video encoding method will be described on the premise that it is performed by a video encoding apparatus.

As illustrated in FIG. 29, the video encoding method according to an embodiment of the first aspect of the present invention includes: determining whether an input video includes patch video content including a patch (S2910); and determining a value of a patch video syntax indicating whether the input video includes the patch video content, based on a result of the determination (S2920).

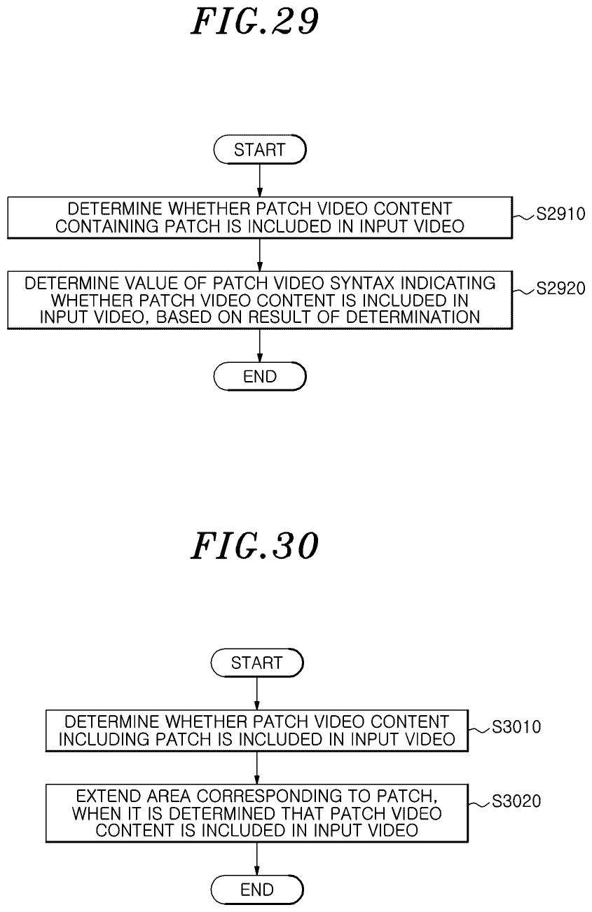

FIG. 30 is a flowchart exemplarily illustrating a video preprocessing method according to another embodiment of the first aspect of the present invention.

As illustrated in FIG. 30, the video preprocessing method according to another embodiment of the first aspect of the present invention includes: determining whether an input video includes patch video content including a patch; and extending an area corresponding to the patch when it is determined that the input video includes the patch video content.

FIG. 31 is a block diagram exemplarily illustrating a video encoding apparatus according to an embodiment of a second aspect of the present invention.

As shown in FIG. 31, a video encoding apparatus 3100 may include an input unit 3110, an output unit 3120, a processor 3130, a memory 3140, and a communication unit 3160.

Hereinafter, for convenience of explanation, it is described by way of example that the video encoding apparatus 3100 includes the input unit 3110, the output unit 3120, the processor 3130, the memory 3140, and the communication unit 3160. However, the present invention is not limited thereto. That is, each of the constituent elements may be implemented outside the video encoding apparatus 3100 and may interact with the video encoding apparatus 3100.

The input unit 3110 may include a user interface configured to receive commands, information, and the like used to control the video encoding apparatus 3100. The input unit 3110 may also be implemented as a hardware device, such as a keyboard, mouse, or touchpad, that directly receives commands, information, and the like used to control the video encoding apparatus 3100.

In one embodiment, the input unit 3110 may receive, from a user, information required for a video encoding method.

The output unit 3120 may provide, via an interface or a display device, visual information to a user, the visual information including information related to the video encoding method.

The processor 3130 may generally control the overall operation of the video encoding apparatus 3100 to perform the present invention.

The processor 3130 may load a video encoding program 3150 and information required to execute the video encoding program 3150 from the memory 3140, and execute the video encoding program 3150.

The processor 3130 may also control the video encoding apparatus 3100 to store data received from an external device via the communication unit 3160 in the memory 3140. Additionally, the processor 3130 may control the video encoding apparatus 3100 to transmit and receive, via the communication unit 3160, information related to the video encoding method to and from an external device.

The processor 3130 may include, but is not limited to, a microprocessor, a central processing unit (CPU), a graphic processing unit (GPU), a processor core, a multiprocessor, an application-specific integrated circuit (ASIC), a field-programmable gate array (FPGA), or a microcontroller unit (MCU).

The memory 3140 may store the video encoding program 3150 and information necessary for the execution of the video encoding program 3150. The memory 3140 may also store processing results generated by the processor 3130.

The video encoding program 3150 may refer to software including instructions programmed to perform the method according to the present invention.

The memory 3140 may store information related to the video encoding method. Additionally, the memory 3140 may store information received from an external device via the communication unit 3160.

The memory 3140 may include, but is not limited to, computer-readable storage media such as magnetic media including hard disks, floppy disks, and magnetic tapes; optical media such as CD-ROMs and DVDs; magneto-optical media such as floptical disks; random access memories (RAM) such as DRAM and SRAM; flash memory; or hardware devices specially configured to store and execute program instructions.

The communication unit 3160 may be a wireless communication module configured to perform wireless communication using communication schemes such as CDMA, GSM, W-CDMA, TD-SCDMA, WiBro, LTE, EPC, 5G, wireless LAN, Wi-Fi, Bluetooth, Zigbee, Wi-Fi Direct (WFD), ultra wideband (UWB), infrared communication (IrDA), Bluetooth Low Energy (BLE), or near field communication (NFC), but is not limited thereto.

Furthermore, the information input and output through the input unit 3110 and the output unit 3120, the information stored in the memory 3140, and the information transmitted and received via the communication unit 3160 may include all information related to the present invention, and are not limited to the above-described embodiments.

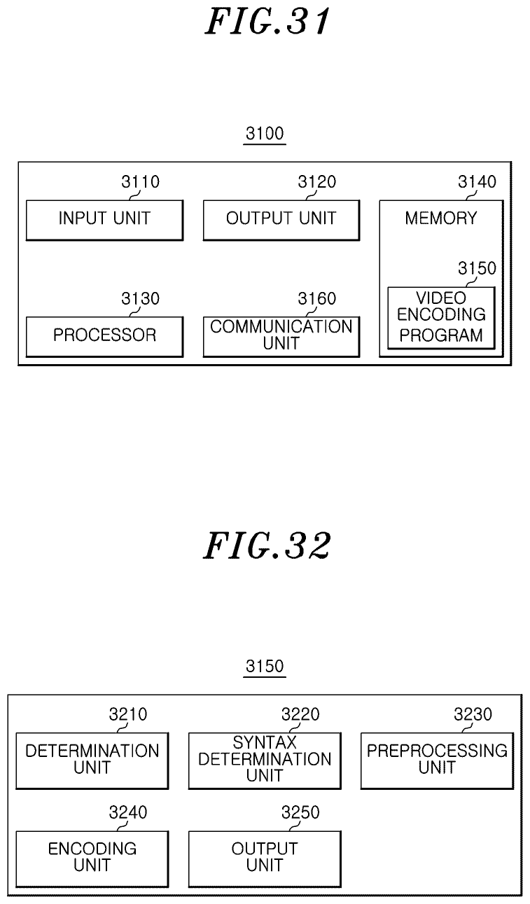

Details regarding the functions or operations of the video encoding program 3150 will be described in detail with reference to FIG. 32.

FIG. 32 is a block diagram exemplarily illustrating functions of a video encoding program.

In some embodiments, the respective functions of the determination unit 3210, the syntax determination unit 3220, the preprocessing unit 3230, the encoding unit 3240, and the output unit 3250 may be merged or separated, and may be implemented as a set of instructions included in at least one program.

The determination unit 3210, the syntax determination unit 3220, the preprocessing unit 3230, the encoding unit 3240, and the output unit 3250 may be implemented by the processor 3130, and may refer to data processing devices embedded in hardware, each having a physically structured circuit for executing functions represented by code or instructions included in the video encoding program 3150 stored in the memory 3140.

The determination unit 3210 may determine whether patch video content containing a patch is included in an input video.

The determination unit 3210 may identify source information of an input video and determine whether the input video includes patch video content.

The syntax determination unit 3220 may determine a value of a patch video syntax indicating whether the patch video content is included in the input video, based on a result of the determination.

The syntax determination unit 3220 may determine a value of a DBF (deblocking filter) syntax indicating whether to apply a DBF.

The patch video content may include a plurality of patches. The syntax determination unit 3220 may apply a deblocking filter (DBF) to block boundaries within the input video if a value of a DBF syntax is 0. In contrast, if the value of the DBF syntax is 1, the syntax determination unit 3220 may not apply the DBF to block boundaries that correspond to patch boundaries.

The syntax determination unit 3220 may determine a value of the patch video syntax as 0 when the input video does not include patch video content. On the contrary, when the input video includes patch video content, the syntax determination unit 3220 may determine a value of the patch video syntax as 1.

When it is determined that the input video includes patch video content, the preprocessing unit 3230 may extend an area corresponding to the patch. In this case, the syntax determination unit 3220 may determine a value of an extension syntax indicating whether the area corresponding to the patch has been extended. For example, when the area corresponding to the patch is not extended, the syntax determination unit 3220 may determine a value of the extension syntax as 0. In contrast, when the area corresponding to the patch is extended, the syntax determination unit 3220 may determine a value of the extension syntax as 1.

The preprocessing unit 3230 may extend an area corresponding to the patch by a predetermined pixel unit for each of top, bottom, left, and right directions of the area corresponding to the patch.

The preprocessing unit 3230 may extend the area corresponding to the patch for each of the top, bottom, left, and right directions by a predetermined ratio with respect to the area corresponding to the patch, for each of top, bottom, left, and right directions of the area corresponding to the patch.

The preprocessing unit 3230 may extend an area based on pixel values of pixels positioned at a boundary of an area corresponding to a patch.

The encoding unit 3240 may encode the input video. Specifically, the encoding unit 3240 may encode the input video based on a value of a patch video syntax. In addition, an operation of encoding the input video may include an operation of generating a bitstream based on values of predetermined syntaxes, such as the patch video syntax, the DBF syntax, or the extension syntax, to encode the input video.

The output unit 3250 may output the encoded video. The output unit 3250 may generate and output a bitstream based on the encoded video and the value of the patch video syntax. In addition, the output unit 3250 may generate and output a bitstream based on the input video and the value of the extension syntax.

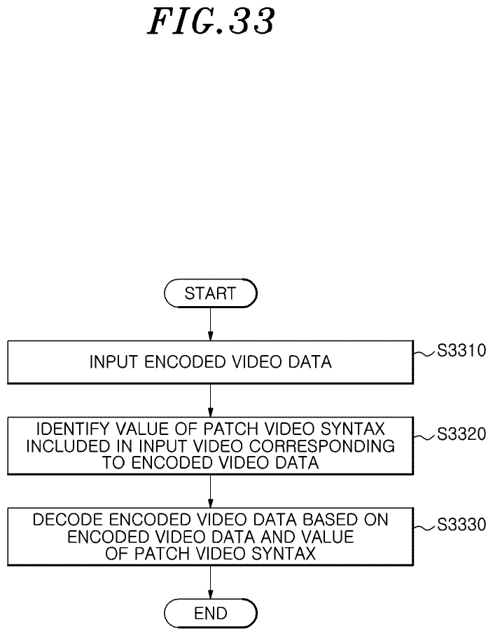

FIG. 33 is a flowchart exemplarily illustrating a video decoding method according to an embodiment of a first aspect of the present invention.

As illustrated in FIG. 33, the video decoding method according to an embodiment of the first aspect of the present invention includes: receiving encoded video data as input (S3310); identifying a value of a patch video syntax indicating whether patch video content including a patch is included in an input video corresponding to the encoded video data (S3320); and decoding the encoded video data based on the encoded video data and the value of the patch video syntax (S3330).

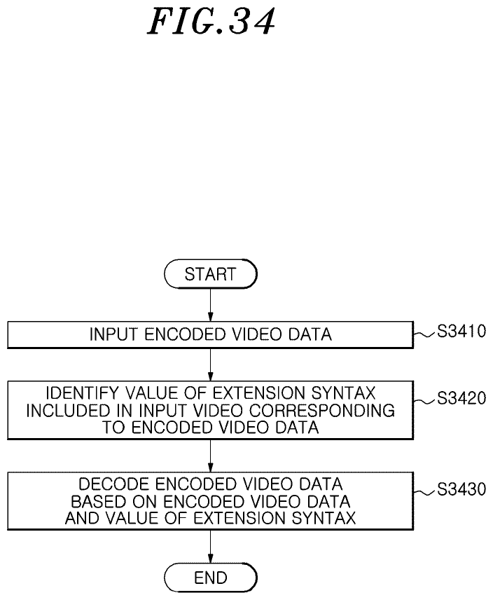

FIG. 34 is a flowchart exemplarily illustrating a video decoding method according to another embodiment of the first aspect of the present invention.

As illustrated in FIG. 34, the video decoding method according to another embodiment of the first aspect of the present invention includes: receiving encoded video data as input (S3410); identifying a value of an extension syntax indicating whether an area corresponding to a patch included in an input video corresponding to the encoded video data has been extended (S3420); and decoding the encoded video data based on the encoded video data and the value of the extension syntax (S3430).

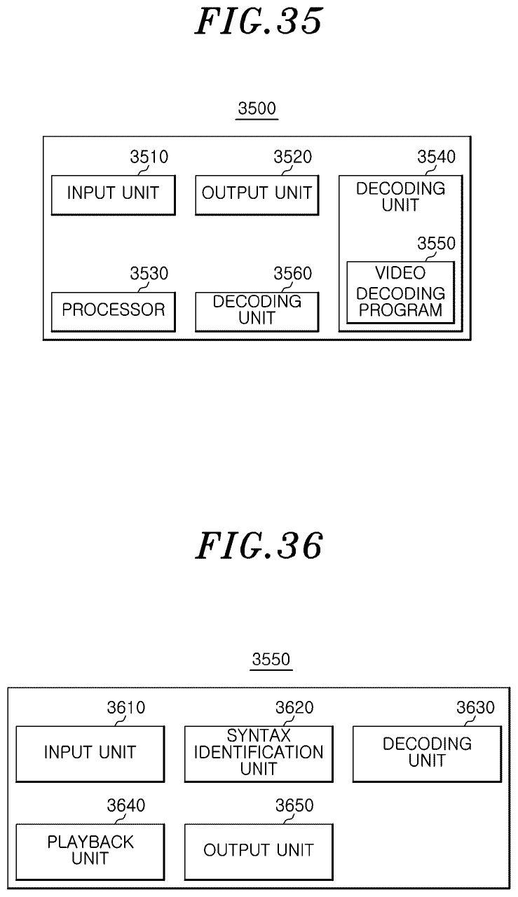

FIG. 35 is a block diagram exemplarily illustrating a video decoding apparatus according to an embodiment of a second aspect of the present invention. Description of the same components as those of the video encoding apparatus 3100 of FIG. 31 will be omitted.

As illustrated in FIG. 35, a video decoding apparatus 3500 may include an input unit 3510, an output unit 3520, a processor 3530, a memory 3540, and a communication unit 3560. Each of the constituent elements may be implemented outside the video decoding apparatus 3500 and may operate in an interactive manner with the video decoding apparatus 3500.

The input unit 3510 may include a user interface configured to receive commands, information, and the like used to control the video decoding apparatus 3500. The input unit 3510 may also be implemented as a hardware device, such as a keyboard, mouse, or touchpad, capable of directly receiving such commands or information.

In one embodiment, the input unit 3510 may receive, from a user, information necessary for performing a video decoding method.

The output unit 3520 may provide, via an interface or display device, visual information to a user, the visual information being related to the video decoding method.

The processor 3530 may generally control overall operations of the video decoding apparatus 3500 to perform the present invention.

The processor 3530 may load a video decoding program 3550 and information required to execute the video decoding program 3550 from the memory 3540, and execute the video decoding program 3550.

The processor 3530 may control the video decoding apparatus 3500 to store data received from an external device via the communication unit 3560 in the memory 3540. Additionally, the processor 3530 may control the video decoding apparatus 3500 to transmit and receive, via the communication unit 3560, information related to the video decoding method to and from an external device.

The memory 3540 may store the video decoding program 3550 and information necessary for executing the video decoding program 3550. The memory 3540 may also store processing results generated by the processor 3530.

The video decoding program 3550 may refer to software including instructions programmed to perform the method according to the present invention.

The memory 3540 may store information related to the video decoding method. Additionally, the memory 3540 may store information received from an external device via the communication unit 3560.

Details regarding the functions or operations of the video decoding program 3550 will be described in detail with reference to FIG. 36.

FIG. 36 is a block diagram exemplarily illustrating functions of a video decoding program.

As illustrated in FIG. 36, the video decoding program 3550 may include an input unit 3610, a syntax identification unit 3620, a decoding unit 3630, a playback unit 3640, and an output unit 3650. The input unit 3610, the syntax identification unit 3620, the decoding unit 3630, the playback unit 3640, and the output unit 3650 exemplify functional components of the video decoding program 3550, and are not limited thereto.

In some embodiments, the respective functions of the input unit 3610, the syntax identification unit 3620, the decoding unit 3630, the playback unit 3640, and the output unit 3650 may be merged or separated, and may be implemented as a set of instructions included in at least one program.

The input unit 3610, the syntax identification unit 3620, the decoding unit 3630, the playback unit 3640, and the output unit 3650 may be implemented by the processor 3530, and may refer to data processing devices embedded in hardware, each having a physically structured circuit for executing functions represented by code or instructions included in the video decoding program 3550 stored in the memory 3540.

The input unit 3610 may receive encoded video data as input.

The syntax identification unit 3620 may check a value of a patch video syntax indicating whether patch video content including a patch is included in an input video corresponding to encoded video data.

The syntax identification unit 3620 may determine whether patch video content is included in the input video based on a value of a patch video syntax.

The syntax identification unit 3620 may determine that the patch video content is not included in the input video when the value of the patch video syntax is 0. On the contrary, the syntax identification unit 3620 may determine that the patch video content is included in the input video when the value of the patch video syntax is 1.

The decoding unit 3630 may decode the encoded video data based on the encoded video data and the value of the patch video syntax.

If the syntax identification unit 3620 determines that patch video content is included in the input video, a decoding unit 3630 may decode the encoded video data based on at least one of: removing an extended area of a patch, or not applying a deblocking filter (DBF) to block boundaries that correspond to patch boundaries.

The playback unit 3640 may play back the decoded video data.

If the syntax identification unit 3620 determines that patch video content is included in the input video, the playback unit 3640 may play back only a partial area of an area corresponding to the patch.

The syntax identification unit 3620 may check a value of an extension syntax indicating whether an area corresponding to a patch included in the input video corresponding to the encoded video data has been extended.

The decoding unit 3630 may decode the encoded video data based on the encoded video data and the value of the extension syntax.

The decoding unit 3630 may determine whether to remove the extended area based on the value of the extension syntax. For example, the decoding unit 3630 may remove the extended area when the value of the extension syntax is 1.

The output unit 3650 may output the decoded video.

As described above, According to the present invention, it may be possible to provide a method of signaling whether a video to be encoded and decoded is a patch video. In addition, it may be possible to provide a method of encoding and decoding an image so that boundaries between patches do not become blurred.

In addition, according to the present invention, when encoding a video, by signaling whether the video is a patch video or an intact video, and not applying DBF when a boundary between blocks matches a boundary between patches, encoding efficiency may be improved and quality of a restored image may be enhanced.

The above-described embodiments of the present invention may be implemented in various ways. For example, the embodiments of the present invention may be implemented by hardware, firmware, software, or any combination thereof.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

1. A method for encoding a video using a video encoding apparatus, the method comprising:
determining whether patch video content containing a patch is included in an input video;
determining a value of a patch video syntax indicating whether the patch video content is included in the input video, based on a result of a determination; and
encoding the input video based on the value of the patch video syntax.

2. The method of claim 1, wherein the encoding the input video includes:
encoding the value of the patch video syntax.

3. The method of claim 1, further comprising:
determining a value of a DBF (deblocking filter) syntax indicating whether to apply a DBF, based on the value of the patch video syntax, and encoding the value of the DBF syntax.

4. The method of claim 3, wherein the patch video content includes a plurality of patches, and
wherein the method comprises:
applying the DBF to block boundaries within the input video or not applying the DBF to block boundaries that correspond to patch boundaries, based on the value of the DBF syntax, with respect to the input video.

5. The method of claim 1, wherein in the determining whether the patch video content is included, source information of the input video is identified to determine whether the patch video content is included in the input video.

6. The method of claim 1, further comprising:
extending an area corresponding to the patch when it is determined that the patch video content is included in the input video.

7. The method of claim 6, wherein in the extending the area, the area corresponding to the patch is extended by a predetermined pixel unit for each of top, bottom, left, and right directions of the area corresponding to the patch.

8. The method of claim 6, wherein in the extending the area, the area corresponding to the patch is extended by a predetermined ratio with respect to the area corresponding to the patch, for each of top, bottom, left, and right directions of the area corresponding to the patch.

9. A method for decoding a video using a video decoding apparatus, the method comprising:
receiving encoded video data as input;
parsing the encoded video data to determine a value of a patch video syntax indicating whether patch video content containing a patch is included in an input video corresponding to the encoded video data; and
decoding the encoded video data based on the encoded video data and the value of the patch video syntax.

10. The method of claim 9, wherein, when it is determined that the patch video content is included in the input video, the decoding the encoded video data includes:
decoding the encoded video data based on at least one of:
removing an extended area of the patch;
or not applying a deblocking filter (DBF) to block boundaries that correspond to patch boundaries.

11. The method of claim 9, further comprising:
playing back the decoded video data,
wherein, when it is determined that the patch video content is included in the input video, the playing back the decoded video data includes playing back only a partial area of an area corresponding to the patch.

12. The method of claim 9, further comprising:
parsing the encoded video data to determine a value of an extension syntax indicating whether an area corresponding to a patch included in the input video corresponding to the encoded video data is extended,
wherein, in the decoding the encoded video data, a determination of whether to remove the extended area is made based on the value of the extension syntax.

13. A non-transitory computer-readable storage medium storing computer-executable instructions, the computer executable instructions, when executed by a processor, cause the processor to perform a method, the method comprising:
determining whether patch video content containing a patch is included in an input video;
determining a value of a patch video syntax indicating whether the patch video content is included in the input video, based on a result of a determination; and
encoding the input video based on the value of the patch video syntax.

14. The non-transitory computer-readable storage medium of claim 13, wherein the encoding the input video includes:
encoding the value of the patch video syntax.

15. The non-transitory computer-readable storage medium of claim 13, the method further comprising:
determining a value of a DBF (deblocking filter) syntax indicating whether to apply a DBF, based on the value of the patch video syntax, and encoding the value of the DBF syntax.

16. The non-transitory computer-readable storage medium of claim 15, wherein the patch video content includes a plurality of patches, and
wherein the method comprises:
applying the DBF to block boundaries within the input video or not applying the DBF to block boundaries that correspond to patch boundaries, based on the value of the DBF syntax, with respect to the input video.

17. The non-transitory computer-readable storage medium of claim 13, wherein in the determining whether the patch video content is included, source information of the input video is identified to determine whether the patch video content is included in the input video.

18. The non-transitory computer-readable storage medium of claim 13, the method further comprising:
extending an area corresponding to the patch when it is determined that the patch video content is included in the input video.

19. The non-transitory computer-readable storage medium of claim 18, wherein in the extending the area, the area corresponding to the patch is extended by a predetermined pixel unit for each of top, bottom, left, and right directions of the area corresponding to the patch.

20. The non-transitory computer-readable storage medium of claim 18, wherein in the extending the area, the area corresponding to the patch is extended by a predetermined ratio with respect to the area corresponding to the patch, for each of top, bottom, left, and right directions of the area corresponding to the patch.
